(19) United States
(12) Patent Application Publication
(10) Pub. No.: US 2026/0203139 A1
(43) Pub. Date: Jul. 16, 2026

(54) GPU RESOURCE ALLOCATION FOR PROCESSING LARGE LANGUAGE MODEL INFERENCE REQUESTS

(71) Applicant: INTERNATIONAL BUSINESS MACHINES CORPORATION, ARMONK, NY (US)

(72) Inventors: Eun Kyung LEE, Bedford Corners, NY (US); Bo Wen, Chappaqua, NY (US); Chen Wang, Chappaqua, NY (US); Huamin Chen, Newton, MA (US)

(21) Appl. No.: 18/956,106

(22) Filed: Nov. 22, 2024

(51) Int. Cl. G06F 9/50; G06F 11/34

(52) U.S. Cl. CPC G06F 9/5094; G06F 9/5011; G06F 11/3433

(57) ABSTRACT

A method, computer program product, and computer system for graphics processing unit (GPU) resource allocation for processing large language model (LLM) inference requests. Inputs of target request rate, target token throughput, and power budget are received. Each iteration of an iterative process includes: (i) monitoring metrics of current request rate, current token throughput, and current power consumption with respect to LLM inference requests submitted to multiple LLMs and processed by GPUs; (ii) calculating, from the monitored metrics, parameters of traffic factor (TF), throughput factor (TPF), power factor (PF), GPU scaling factor (GSF), and MIG scaling factor (MSF) via TF=current request rate/target request rate, TPF=target token throughput/current token throughput, PF=power budget/current power consumption; and (iii) converting as a function of GSF, MSF, and PF: (i) Multi-Instance GPU (MIG) service to GPU service or (ii) GPU service to MIG service.

### BACKGROUND

The present invention relates to processing large language model (LLM) inference requests and more specifically to graphics processing unit (GPU) resource allocation for processing LLM inference requests.

### SUMMARY

Embodiments of the present invention provide a method, a computer program product, and a computer system, for graphics processing unit (GPU) resource allocation for processing large language model (LLM) inference requests.

1One or more processors of a computer system receive inputs of target request rate, target token throughput, and power budget.

1The one or more processors perform an 1iterative process, wherein each iteration of the iterative process comprises: (i) 1monitoring metrics of current request rate, current token throughput, and current power consumption with respect to LLM inference requests submitted to multiple LLMs and processed by one or more GPUs; (ii) 1calculating, from the monitored metrics, parameters of traffic factor (TF), throughput factor (TPF), power factor (PF), GPU scaling factor (GSF), and MIG scaling factor (MSF) via TF=current request rate/target request rate, TPF=target token throughput/the current token throughput, PF=power budget/the current power consumption; and (iii) 1converting (i) Multi-Instance GPU (MIG) service to GPU service or (ii) GPU service to the MIG service, said converting being implemented as a function of the GSF, the MSF, and the PF.

### BRIEF DESCRIPTION OF THE DRAWINGS

FIG. 1 depicts a configuration of a GPU partitioned into three MIG devices, in accordance with embodiments of the present invention.

FIG. 2 is a flow chart of GPU resource allocation for processing multiple LLM inference requests submitted to multiple LLMs, in accordance with embodiments of the present invention.

FIG. 3 is a flow chart of a process describing changing a current GPU-MIG state resulting from converting MIG service to GPU service, in accordance with embodiments of the present invention.

FIG. 4 is a flow chart of a process describing changing a current GPU-MIG state resulting from converting GPU service to MIG service, in accordance with embodiments of the present invention.

FIG. 5 illustrates a computer system, in accordance with embodiments of the present invention.

FIG. 6 depicts a computing environment which contains an example of an environment for the execution of at least some of the computer code involved in performing the inventive methods, in accordance with embodiments of the present invention.

### DETAILED DESCRIPTION

Large language models (LLMs) have become increasingly popular for natural language processing (NLP) tasks, such as text generation, translation, and summarization. However, running inference on these LLMs can be computationally expensive, requiring significant graphics processing unit (GPU) resources to achieve acceptable performance.

An LLM inference request refers to the process of submitting input data (such as text) to a pre-trained LLM and obtaining a prediction or response from the LLM, which may involve, inter alia: a user submitting a text prompt or query to the LLM, processing by the LLM the input based on the LLM's pre-trained knowledge, including syntax, semantics, and patterns the LLM has learned from large datasets. During LLM inference, no new learning occurs and the LLM applies the knowledge that the LLM already has to generate the output.

A GPU is a specialized electronic circuit designed to accelerate the processing of images, videos, and other visual output. A GPU can also be used for general-purpose computing tasks, including tasks that can be parallelized.

One challenge in deploying LLM inference at scale is optimizing GPU resource allocation and cost-effectiveness while maintaining high performance. Traditional GPU allocation methods may not be efficient for processing LLM inference requests, since traditional GPU allocation can result in underutilized resources, high power consumption, and/or high costs.

Furthermore, LLM inference request traffic can be unpredictable and vary significantly over time, making it challenging to determine an optimal number of GPUs and microservice replicas needed to handle the workload efficiently, which can lead to either over-provisioning of resources, resulting in wasted costs, or under-provisioning, resulting in poor performance and increased latency.

To address these challenges, embodiments of the present invention provide dynamic scaling and allocation of GPU resources between first and second microservices based on LLM inference request traffic and token throughput per second to improve the performance of LLM inference.

The first microservice uses an entire GPU for processing LLM inference requests, while the second microservice uses Multi-Instance GPU (MIG) technology.

MIG technology allows a single GPU to be partitioned into multiple MIG instances, each instance being a virtual device having its own memory and computational resources. MIG can improve resource utilization and reduce costs for workloads that do not require the full capacity of a GPU. Even though one GPU is shared among multiple users, the user experience is the same as using a dedicated GPU unlike the multi-process service (mps) where users share the memory space. Also, the performance is guaranteed due to isolated resources usage of MIG. Although conventional usage of MIG may not provide optimal performance for LLM inference, depending on the workload and resource requirements, embodiments of the present invention utilize MIG in a manner that optimizes performance of LLM inference.

Each MIG device is allocated a portion of the GPU's memory, depending on the size of the MIG device. MIG devices cannot be assigned arbitrary memory sizes but instead use predefined memory sizes associated with the device's partition (e.g., 1/7th, ¼th, etc.).

MIG devices are created from a limited pool of available resources, including the number of compute instances, memory, and memory controllers.

Each MIG has a fixed number of streaming multiprocessors (SMs), and multiple MIG devices can run in parallel.

The number and sizes of the MIG devices permitted for a specific GPU must fit within predefined configurations based on the specific GPU. Each configuration is characterized by the number of MIG devices and specified sizes of the MIG devices.

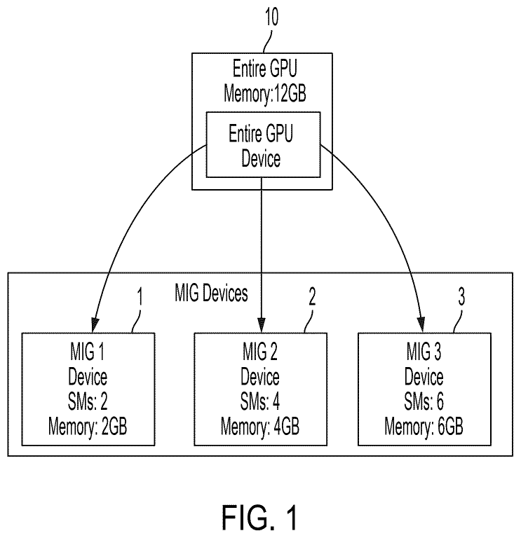

FIG. 1 depicts a configuration of a GPU 10 partitioned into three MIG devices 1, 2 and 3, in accordance with embodiments of the present invention.

The GPU 10 has a memory of 12 GB.

MIG device 1 has a memory of 2 GB and includes 2 SMs.

MIG device 2 has a memory of 4 GB and includes 4 SMs.

MIG device 3 has a memory of 6 GB and includes 6 SMs.

Another configuration for partitioning the GPU 10 into multiple MIG devices is partitioning the GPU 10 into 2 MIG devices with each MIG device having a memory of 6 GB.

Another configuration for partitioning the GPU 10 into multiple MIG devices is partitioning the GPU 10 into 3 MIG devices with each MIG device having a memory of 4 GB.

Another configuration for partitioning the GPU 10 into multiple MIG devices is partitioning the GPU 10 into 4 MIG devices with each MIG device having a memory of 3 GB.

Another configuration for partitioning the GPU 10 into multiple MIG devices is partitioning the GPU 10 into 5 MIG devices with each MIG device having a memory of 2.4 GB.

Another configuration for partitioning the GPU 10 into multiple MIG devices is partitioning the GPU 10 into 5 MIG devices with (i) 2 MIG devices each having a memory of 3 GB and (ii) 3 MIG devices each having a memory of 2 GB.

Another configuration for partitioning the GPU 10 into multiple MIG devices is partitioning the GPU 10 into 2 MIG devices with each MIG device having a memory of 2 GB.

Embodiments of the present invention process LLM inferences for multiple LLMs by utilizing one or more GPUs.

For each GPU of the one or more GPUs, either the entire GPU is used for processing LLM inference requests or the GPU is partitioned into multiple MIG devices with each MIG device processing LLM inferences for only one LLM. Thus, each MIG device is used by only one LLM.

A GPU processes an LLM inference via execution of a specific LLM to respond to the LLM inference that was submitted to the specific LLM, wherein the specific LLM resides in the GPU.

If the GPU is partitioned into multiple MIG devices, the GPU processes the LLM inference via execution of a specific LLM to respond to the LLM inference that was submitted to the specific LLM, wherein the specific LLM resides in one of the MIG devices in the GPU.

The one or more GPUs are characterized by a GPU-MIG state that can change dynamically with time. There are three possible GPU-MIG states, namely a pure GPU state, a pure MIG state, and a mixed GPU-MIG state.

In the pure GPU state, the entire GPU of each GPU of the one or more GPUs is used for processing LLM inference requests, so that the one or more GPUs are in the pure GPU state.

In the pure MIG state, each GPU of the one or more GPUs is partitioned into multiple MIG devices for processing LLM inference requests submitted to the multiple LLMs, so that the one or more GPUs are in the pure MIG state.

In the mixed GPU-MIG state, (i) the entire GPU of at least one GPU of the one or more GPUs is used for processing LLM inference requests and (2) at least one GPU of the one or more GPUs is partitioned into multiple MIG devices for processing LLM inference requests.

Thus, the mixed GPU-MIG state is characterized by: (i) some LLM inference requests being processed by at least one GPU such that the entire GPU of at the least one GPU is used for processing the some LLM inference requests and (ii) other LLM inference requests being processed by at least one GPU such that the least one GPU is partitioned into multiple MIG devices for processing the ther LLM inference requests.

Embodiments of the present invention use metrics (current request rate, current token throughput, current power consumption) and related inputs (target request rate, target token throughput, power budget) to process the LLM inference requests submitted to the multiple LLMs.

The current request rate is defined as the number of LLM inference requests per second submitted to the multiple LLMs. The current request rate is a measure of current demand for processing LLM inference requests submitted to the multiple LLMs.

The current token throughput is defined as the number of tokens per second processed by the one or more GPUs in response to the LLM inference requests submitted to the multiple LLMs. A token is a meaningful chunk of text (e.g., a word, phrase, etc.) processed (e.g., parsed) by the multiple LLMs. The current token throughput is a measure of current performance of the one or more GPUs for processing the LLM inference requests submitted to the multiple LLMs.

The current power consumption is defined as the power consumed (e.g., in watts) by the multiple GPU for processing the LLM inference requests submitted to the multiple LLMs. The current power consumption is a measure of energy efficiency of processing the LLM inference requests submitted to the multiple LLMs.

The target request rate is defined as a desired request rate of LLM inference requests submitted to the multiple the one or more GPUs to be processed by the one or more GPUs.

The target token throughput is defined as a desired throughput of tokens per second to be processed by the one or more GPUs in response to the LLM inference requests submitted to the multiple LLMs.

The power budget is defined as a desired amount of power to be consumed by the multiple GPU for processing the LLM inference requests submitted to the multiple LLMs.

Embodiment of the present invention calculate parameters of traffic factor (TF), throughput factor (TPF), power factor (PF), GPU scaling factor (GSF), and MIG scaling factor (MSF) via Equations (1)-(5).

$$TF = current request rate / target request rate \qquad ( 1 )$$

$$TPF = target token throughput / current token throughput \qquad ( 2 )$$

$$PF = power budget / current power consumption \qquad ( 3 )$$

$$GSF = TF * TPF * PF \qquad ( 4 )$$

$$MSF = ( 1 / TF ) * ( 1 / TPF ) * ( 1 / PF ) = 1 / ( GSF ) \qquad ( 5 )$$

Parameters N_{TOT}, N_{M}, and N_{G} are defined as follows.

N_{TOT} is the total number of GPUs (i.e., the one or more GPUs) used to process the multiple LLM inference requests.

N_{M} is the number of GPUs currently partitioned into MIG devices for processing LLM inference requests.

N_{G} is the number of GPUs currently used entirely for processing LLM inference requests and are not currently partitioned into MIG devices.

N_{TOT}, N_{M}, and N_{G} satisfy Equation (6).

$${N}_{TOT} = {N}_{M} + {N}_{G} \qquad ( 6 )$$

NM and NG dynamically change over time, and N_{TOT} is constant over time.

MIG service is defined as service using GPUs partitioned into MIG devices for processing LLM inference requests. A necessary condition for implementing MIG service is N_{M}>0. A pure GPU state is characterized by N_{M}=0 and thus cannot provide MIG service.

GPU service is defined as service using entire GPUs for processing LLM inference requests, wherein such entire GPUs are not partitioned into MIG devices. A necessary condition for implementing GPU service is N_{G}>0. A pure MIG state is characterized by N_{G}=0 and thus cannot provide GPU service.

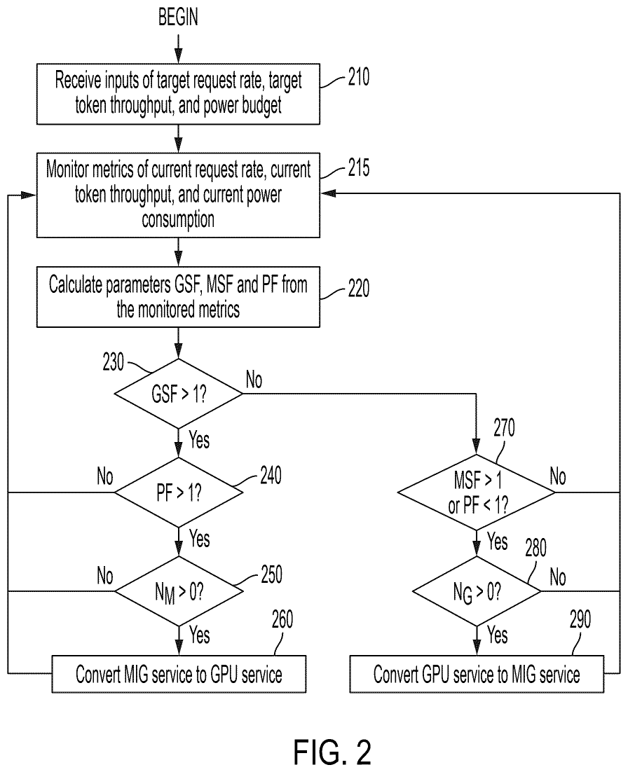

FIG. 2 is a flow chart of GPU resource allocation for processing LLM inference requests, in accordance with embodiments of the present invention. The flow chart of FIG. 2 includes steps 210-290.

Step 210 receives inputs of target request rate, target token throughput, and power budget.

Steps 215-290 is an iterative process, wherein each iteration of the iterative process includes performing a subset of steps 215-290.

Step 215 monitors metrics of current request rate, current token throughput, and current power consumption.

Step 220 calculates parameters GSF, MSF and PF, from the monitored metrics, via Equations (1)-(5) stated supra.

Step 230 determines whether GSF>1. If so (Yes branch from step 230), step 240 is next executed. If not (No branch from step 230), step 270 is next executed.

Step 240 determines whether PF>1. If so (Yes branch from step 240), step 250 is next executed. If not (No branch from step 240), processing loops back to step 215 to resume the monitoring of the metrics to perform a next iteration.

Step 250 determines whether N_{M}>0. If so (Yes branch from step 250), step 260 is next executed. If not (No branch from step 250), processing loops back to step 215 to resume the monitoring of the metrics to perform a next iteration, because N_{M}=0 and thus there is no existing MIG service to convert to GPU service in step 260. If N_{M}>0 then the one or more GPUs that process the multiple LLM requests are not in a pure GPU state.

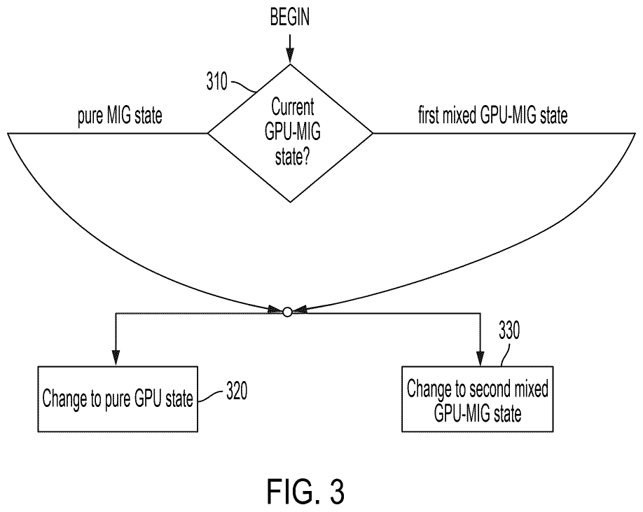

Step 260 converts MIG service to GPU service, after which processing loops back to step 215 to resume the monitoring of the metrics. Step 260 is described infra in more detail in FIG. 3.

Converting MIG service to GPU service comprises changing at least one GPU (that is currently partitioned into multiple MIG devices for processing LLM inference requests) to at least one GPU with no included MIG devices and configured to be used in its entirety for processing LLM inference requests.

Step 270 determines whether MSF>1 or PF<1. If so (Yes branch from step 270), step 280 is next executed. If not (No branch from step 270), processing loops back to step 215 to resume the monitoring of the metrics to perform a next iteration.

Step 280 determines whether N_{G}>0. If so (Yes branch from step 280), step 290 is next executed. If not (No branch from step 280), processing loops back to step 215 to resume the monitoring of the metrics to perform a next iteration, because N_{G}=0 and thus there is no existing GPU service to convert to MIG service in step 290. If N_{G}>0 then the one or more GPUs that process the multiple LLM requests are not in a pure MIG state.

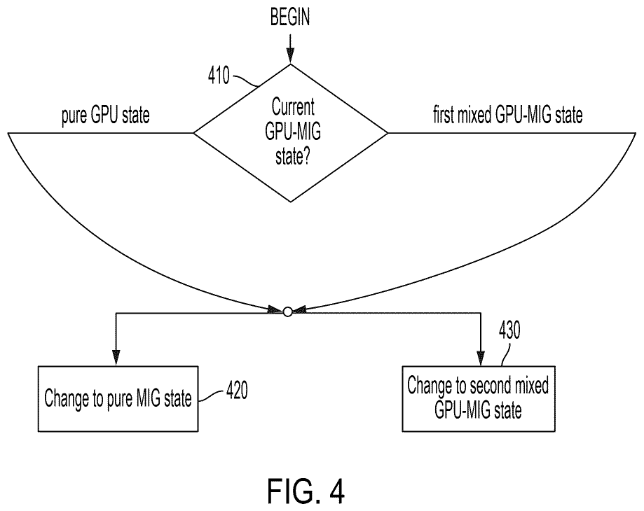

Step 290 converts GPU service to MIG service, after which processing loops back to step 215 to resume the monitoring of the metrics to perform a next iteration. Step 290 is described in more detail in FIG. 4 described infra.

Converting GPU service to MIG service comprises partitioning at least one GPU (that does not currently include any MIG devices and is currently used in its entirety for processing the LLM inference requests) into multiple MIG devices for processing LLM inference requests.

FIG. 3 is a flow chart of a process describing changing a current GPU-MIG state resulting from converting MIG service to GPU service, in accordance with embodiments of the present invention. The flow chart of FIG. 3, which includes steps 310-330, describes step 260 of FIG. 2 in more detail.

Step 310 determines whether a current GPU-MIG state is a pure MIG state (N_{G}=0) or a first mixed GPU-MIG state (N_{G}>0, N_{M}>0) and in response, step 320 or step 330 is next executed.

In response to step 310 determining that the current GPU-MIG state is the pure MIG state (N_{G}=0), step 320 changes the current pure MIG state (N_{G}=0) to a pure GPU state (N_{M}=0), and step 330 changes the current pure MIG state (N_{G}=0) to a second mixed GPU-MIG state (N_{G}>0, N_{M}>0).

In response to step 310 determining that the current GPU-MIG state is the first mixed GPU-MIG state (N_{G}>0, N_{M}>0), step 320 changes the current first mixed GPU-MIG state (N_{G}>0, N_{M}>0) to a pure GPU state (N_{M}=0), and step 330 changes the current first mixed GPU-MIG state (N_{G}>0, N_{M}>0) to a second mixed GPU-MIG state (N_{G}>0, N_{M}>0).

The condition of N_{G}>0 is equivalent to N_{G}≥1, and the condition of N_{M}>0 is equivalent to N_{M}≥1.

Step 320 is implemented by removing all MIG devices from all GPUs that are currently partitioned into MIG devices for processing LLM inference requests, resulting in (i) the entire GPU in all GPUs of the at least one GPU processing the LLM inference requests and (ii) no MIG device processing any LLM inference request.

Step 330 is implemented by removing all MIG devices from one GPU that is currently partitioned into MIG devices for processing LLM inference requests, resulting in the GPU-MIG state characterized by N_{G}>0, N_{M}>0; i.e., resulting in (i) at least one GPU not including any MIG device and having its entire GPU configured to process LLM inference requests and (ii) at least one GPU partitioned into MIG devices for processing LLM inference requests.

The one GPU from which all MIG devices are removed in step 330 is randomly selected, from a uniform probability distribution, from all GPUs currently partitioned into MIG devices.

If the current GPU-MIG state is characterized by N_{M}=1, then step 320 must be executed, and step 330 cannot be executed, in response to step 310 determining whether a current GPU-MIG state is a pure MIG state (N_{G}=0) or a first mixed GPU-MIG state (N_{G}>0, N_{M}>0).

If the current GPU-MIG state is characterized by N_{M}>1, then either step 320 or step 330 can be executed, and whether step 320 or step 330 is executed is determined by user input which specifies whether to execute step 320 or 330 under conditions in which it is possible to execute step 320 or step 330.

FIG. 4 is a flow chart of a process describing changing a current GPU-MIG state resulting from converting GPU service to MIG service, in accordance with embodiments of the present invention. The flow chart of FIG. 4, which includes steps 410-430, describes step 290 of FIG. 2 in more detail.

Step 410 determines whether a current GPU-MIG state is a pure GPU state (N_{M}=0) or a first mixed GPU-MIG state (N_{G}>0, N_{M}>0) and in response, step 420 or step 430 is next executed.

In response to step 410 determining that the current GPU-MIG state is the pure GPU state (N_{M}=0), step 420 changes the current pure GPU state (N_{M}=0) to a pure MIG state (N_{G}=0), and step 430 changes the current pure GPU state (N_{M}=0) to a second mixed GPU-MIG state (N_{G}>0, N_{M}>0).

In response to step 410 determining that the current GPU-MIG state is the first mixed GPU-MIG state (N_{G}>0, N_{M}>0), step 420 changes the current first mixed GPU-MIG state (N_{G}>0, N_{M}>0) to a pure MIG state (N_{G}=0), and step 430 changes the current first mixed GPU-MIG state (N_{G}>0, N_{M}>0) to a second mixed GPU-MIG state (N_{G}>0, N_{M}>0).

The condition of N_{G}>0 is equivalent to N_{G}≥1, and the condition of N_{M}>0 is equivalent to N_{M}≥1.

Step 420 is implemented by partitioning each GPU device (not currently partitioned into MIG devices) into MIG devices for processing LLM inference requests, resulting in all GPUs being partitioned into MIG devices.

Step 430 is implemented by partitioning one GPU (that is currently not partitioned into MIG devices) into MIG devices for processing LLM inference requests, resulting in the GPU-MIG state characterized by N_{G}>0, N_{M}>0; i.e., resulting in (i) at least one GPU not including any MIG device and having its entire GPU configured to process LLM inference requests and (ii) at least one GPU being partitioned into MIG devices for processing LLM inference requests.

The one GPU that is being partitioned into MIG devices in step 430 is randomly selected, from a uniform probability distribution, from all GPUs not currently partitioned into MIG devices.

If the current GPU-MIG state is characterized by N_{G}=1, then step 420 must be executed, and step 430 cannot be executed, in response to step 410 determining whether a current GPU-MIG state is a pure GPU state (N_{M}=0) or a first mixed GPU-MIG state (N_{G}>0, N_{M}>0).

If the current GPU-MIG state is characterized by N_{G}>1, then either step 420 or step 430 can be executed, and whether step 420 or step 430 is executed is determined by user input which specifies whether to execute step 420 or 430 under conditions in which it is possible to execute step 420 or step 430.

As explained supra, each GPU has predefined configurations of MIG devices with each configuration being characterized by the number of MIG devices and specified sizes of the MIG devices. Thus, one of the predefined configurations needs to be selected for each GPU to be partitioned into MIG devices.

In one embodiment, a predefined configuration for a given GPU is selected based on the MIG device sizes being sufficient to enable all MIG devices in the given GPU to store an LLM that processes LLM inference requests. If more than one predefined configuration has MIG devices of sizes sufficient to enable all MIG devices in the given GPU to store an LLM that processes LLM inference requests, then the predefined configuration is randomly selected from the more than one predefined configuration from a uniform probability distribution.

For each GPU partitioned into MIG devices for processing LLM inference requests, any MIG device not being used to process LLM inference requests may be used for executing another (i.e., non-LLM) application.

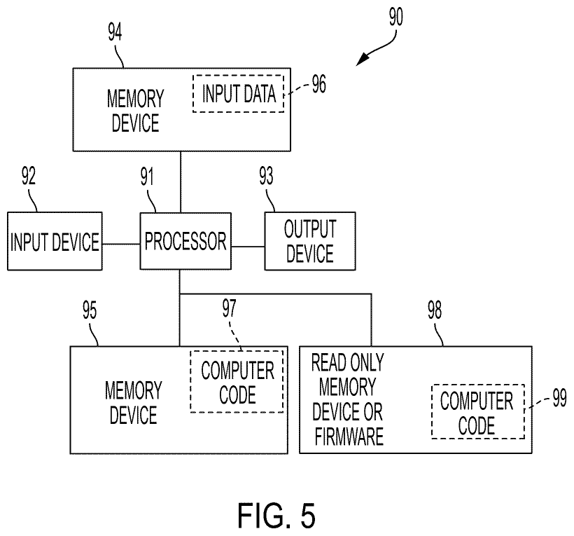

FIG. 5 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

1A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

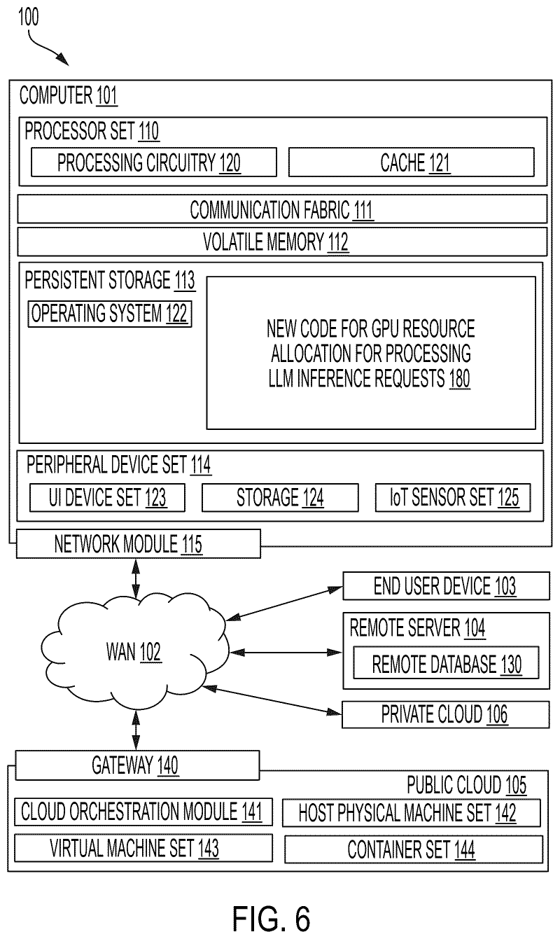

FIG. 6 depicts a computing environment 100 which contains an example of an environment for the execution of at least some of the computer code involved in performing the inventive methods, in accordance with embodiments of the present invention. Such computer code includes new code for GPU resource allocation for processing LLM inference requests 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

11. A method for graphics processing unit (GPU) resource allocation for processing large language model (LLM) inference requests, said method comprising:
receiving, by one or more processors of a computer system, inputs of target request rate, target token throughput, and power budget;
performing, by the one or more processors, an iterative process, wherein each iteration of the iterative process comprises:
monitoring metrics of current request rate, current token throughput, and current power consumption with respect to LLM inference requests submitted to multiple LLMs and processed by one or more GPUs;
calculating, from the monitored metrics, parameters of traffic factor (TF), throughput factor (TPF), power factor (PF), GPU scaling factor (GSF), and MIG scaling factor (MSF) via TF=current request rate/target request rate, TPF=target token throughput/the current token throughput, PF=power budget/the current power consumption; and
converting (i) Multi-Instance GPU (MIG) service to GPU service or (ii) the GPU service to the MIG service, said converting being implemented as a function of the GSF, the MSF, and the PF.

2. The method of claim 1, wherein during one iteration of the iterative process, the one iteration comprises:
determining that GSF>1, PF>1, and the one or more GPUs are not in a pure GPU state and in response, converting, by the one or more processors, the MIG service to the GPU service.

3. The method of claim 2, wherein said converting results in a current GPU-MIG state changing from a pure MIG state to the pure GPU state or to a mixed GPU-MIG state.

4. The method of claim 2, wherein said converting results in a current GPU-MIG state changing from a first mixed GPU-MIG state to the pure GPU state or to a second mixed GPU-MIG state.

5. The method of claim 1, wherein during one iteration of the iterative process, the one iteration comprises:
determining that the MSF>1 or the PF<1, and the one or more GPUs are not in a pure MIG state and in response, converting, by the one or more processors, the GPU service to the MIG service.

6. The method of claim 5, wherein said converting results in a current GPU-MIG state changing from a pure GPU state to the pure MIG state or to a mixed GPU-MIG state.

7. The method of claim 5, wherein said converting results in a current GPU-MIG state changing from a first mixed GPU-MIG state to a pure MIG state or to a second mixed GPU-MIG state.

8. A computer program product, comprising one or more computer readable hardware storage devices having computer readable program code stored therein, said program code containing instructions executable by one or more processors of a computer system to implement a method for graphics processing unit (GPU) resource allocation for processing large language model (LLM) inference requests, said method comprising:
receiving, by the one or more processors, inputs of target request rate, target token throughput, and power budget;
performing, by the one or more processors, an iterative process, wherein each iteration of the iterative process comprises:
monitoring metrics of current request rate, current token throughput, and current power consumption with respect to LLM inference requests submitted to multiple LLMs and processed by one or more GPUs;
calculating, from the monitored metrics, parameters of traffic factor (TF), throughput factor (TPF), power factor (PF), GPU scaling factor (GSF), and MIG scaling factor (MSF) via TF=current request rate/target request rate, TPF=target token throughput/the current token throughput, PF=power budget/the current power consumption; and
converting (i) Multi-Instance GPU (MIG) service to GPU service or (ii) the GPU service to the MIG service, said converting being implemented as a function of the GSF, the MSF, and the PF.

9. The computer program product of claim 8, wherein during one iteration of the iterative process, the one iteration comprises:
determining that GSF>1, PF>1, and the one or more GPUs are not in a pure GPU state and in response, converting, by the one or more processors, the MIG service to the GPU service.

10. The computer program product of claim 9, wherein said converting results in a current GPU-MIG state changing from a pure MIG state to the pure GPU state or to a mixed GPU-MIG state.

11. The computer program product of claim 9, wherein said converting results in a current GPU-MIG state changing from a first mixed GPU-MIG state to the pure GPU state or to a second mixed GPU-MIG state.

12. The computer program product of claim 8, wherein during one iteration of the iterative process, the one iteration comprises:
determining that the MSF>1 or the PF<1, and the one or more GPUs are not in a pure MIG state and in response, converting, by the one or more processors, the GPU service to the MIG service.

13. The computer program product of claim 12, wherein said converting results in a current GPU-MIG state changing from a pure GPU state to the pure MIG state or to a mixed GPU-MIG state.

14. The computer program product of claim 12, wherein said converting results in a current GPU-MIG state changing from a first mixed GPU-MIG state to a pure MIG state or to a second mixed GPU-MIG state.

15. A computer system, comprising one or more processors, one or more memories, and one or more computer readable hardware storage devices, said one or more hardware storage devices containing program code executable by the one or more processors via the one or more memories to implement a method for graphics processing unit (GPU) resource allocation for processing large language model (LLM) inference requests, said
a computer system, inputs of target request rate, target token throughput, and power budget;
performing, by the one or more processors, an iterative process, wherein each iteration of the iterative process comprises:
monitoring metrics of current request rate, current token throughput, and current power consumption with respect to LLM inference requests submitted to multiple LLMs and processed by one or more GPUs;
calculating, from the monitored metrics, parameters of traffic factor (TF), throughput factor (TPF), power factor (PF), GPU scaling factor (GSF), and MIG scaling factor (MSF) via TF=current request rate/target request rate, TPF=target token throughput/the current token throughput, PF=power budget/the current power consumption; and
converting (i) Multi-Instance GPU (MIG) service to GPU service or (ii) the GPU service to the MIG service, said converting being implemented as a function of the GSF, the MSF, and the PF.

16. The computer system of claim 15, wherein during one iteration of the iterative process, the one iteration comprises:
determining that GSF>1, PF>1, and the one or more GPUs are not in a pure GPU state and in response, converting, by the one or more processors, the MIG service to the GPU service.

17. The computer system of claim 16, wherein said converting results in a current GPU-MIG state changing from a pure MIG state to the pure GPU state or to a mixed GPU-MIG state.

18. The computer system of claim 16, wherein said converting results in a current GPU-MIG state changing from a first mixed GPU-MIG state to the pure GPU state or to a second mixed GPU-MIG state.

19. The computer system of claim 15, wherein during one iteration of the iterative process, the one iteration comprises:
determining that the MSF>1 or the PF<1, and the one or more GPUs are not in a pure MIG state and in response, converting, by the one or more processors, the GPU service to the MIG service.

20. The computer system of claim 19, wherein said converting results in a current GPU-MIG state changing from a pure GPU state to the pure MIG state or to a mixed GPU-MIG state.
